(19) United States
(12) Patent Application Publication
(10) Pub. No.: US 2013/0136415 A1
(43) Pub. Date: May 30, 2013

(54) System and Method for Managing Playback Sensitive Content

(71) Applicant: Prem Hareesh, Marina Del Ray, CA (US)

(72) Inventor: Prem Hareesh, Marina Del Ray, CA (US)

(73) Assignee: Cisco Technology Inc., San Jose,, CA (US)

(21) Appl. No.: 13/805,304

(22) PCT Filed: Jun. 16, 2011
(86) PCT No.: PCT/IB2011/052629

§ 371 Date: Jan. 8, 2013

Related U.S. Application Data
(60) Provisional application No. 61/398,581, filed on Jun. 28, 2010.

(30) Foreign Application Priority Data
Aug. 24, 2010 (GB) 1014098.6

(51) Int. Cl. H04N 9/87; H04N 5/775

(52) U.S. Cl. CPC H04N 9/87; H04N 5/775
USPC 386/230; 386/241

(57) ABSTRACT

A method for managing play-back sensitive content for a media playback device, including providing a content package including at least one non-playback sensitive media unit and a plurality of playback sensitive media units, receiving the content package by the media playback device, determining at least one playback condition upon initiation of playback by the media playback device, and selecting at least one playback sensitive media unit from the plurality of playback sensitive media units according to the at least one playback condition to form a selected playback sensitive media unit. Related apparatus and methods are also described.

### FIELD OF THE INVENTION

The present invention relates to a system and method for managing playback sensitive content, and in particular but not exclusively, to such a system and method for managing and displaying such content for a media playback device.

### BACKGROUND OF THE INVENTION

Time-shifted viewing is made possible by Digital Video Recorders (DVRs). With the increasing popularity of such DVRs, the concept of a time-delimited viewership is quickly eroding. However, the ability to watch any content at any time can cause at least some of the content to lose its relevancy, for example with regard to advertisements that relate to a particular event or otherwise which have time related sensitivity. Therefore simply playing back the recorded content could result in playback of content that is no longer relevant, due for example to the delay between recording and playback of the content.

References relevant to the subject of accessing information about television programs and/or channels include U.S. Pat. No. 7,340,760 to Wachtfogel et al; published US Patent Application No. 2007/0136742 to Sparrell et al; published US Patent Application No. 2007/0078715 to Murakami et al; published US Patent Application No. 2008/0127246 to Sylvain.

Other types of content related sensitivity for playback include, without limitation, content that is particularly suited or designated for a specific recipient. Such content may be selected for this recipient, regardless of whether the content is recorded. References relevant to the subject of accessing information about television programs and/or channels include U.S. Pat. No. 6,698,020 to Zigmond; and U.S. Pat. No. 6,075,551 to Berezowski et al.

References relevant to the subject of “splicing” or combining video data include published PCT Application No. WO 2004/072935 to Shelton et al, published PCT Application No. WO 2005/122688 to White et al, and published PCT Application No. WO 2009/133427 to Taylor et al.

### SUMMARY OF THE INVENTION

The present invention, in certain embodiments thereof, seeks to provide an improved system and method for managing media playback.

The present invention, in at least some embodiments seeks to provide a system and method for managing playback sensitive content for a media playback device. The playback sensitive content is managed by first being packaged in a content package comprising at least one non-playback sensitive media unit and a plurality of playback sensitive media units. After the content package is received by the media playback device and at least one playback condition is determined, the media playback device selects at least one playback sensitive media unit from the plurality of playback sensitive media units according to at least one playback condition to form a selected playback sensitive media unit. The media playback device may then optionally play back both the at least one non-playback sensitive media unit and the selected playback sensitive media unit.

As described herein, the term “playback” refers to both recorded content and also streamed or live content, which may optionally be requested “on demand”.

There is thus provided in accordance with an embodiment of the present invention a method for managing playback sensitive content for a media playback device, including providing a content package including at least one non-playback sensitive media unit and a plurality of playback sensitive media units, receiving the content package by the media playback device, determining at least one playback condition upon initiation of playback by the media playback device, and selecting at least one playback sensitive media unit from the plurality of playback sensitive media units according to the at least one playback condition to form a selected playback sensitive media unit.

Further in accordance with an embodiment of the present invention the method further includes playing back the at least one non-playback sensitive media unit and the selected playback sensitive media unit by the media playback device.

Still further in accordance with an embodiment of the present invention the providing the content package includes adding a label to each playback sensitive media unit, the label including playback data regarding at least one playback condition, and wherein the determining the at least one playback condition includes reading the playback data from the label.

Additionally in accordance with an embodiment of the present invention the providing the content package includes constructing each playback sensitive media unit with at least one constant portion and at least one variable portion, wherein the at least one constant portion is shared by the plurality of playback sensitive media units.

Moreover in accordance with an embodiment of the present invention the packaging the content package includes packaging a single copy of each constant portion with a plurality of variable portions to form the plurality of playback sensitive media units, and wherein the selecting the at least one playback sensitive media unit for playback includes selecting the single copy of each constant portion and each variable portion of the at least one playback sensitive media unit for playback.

Further in accordance with an embodiment of the present invention the constructing each playback sensitive media unit further includes labeling each variable portion with the label including playback data regarding at least one playback condition and at least one playback instruction, the at least one playback instruction including information for playing back the variable portion.

Still further in accordance with an embodiment of the present invention the packaging the single copy of each constant portion with the plurality of variable portions to form the plurality of playback sensitive media units further includes adding a playback sensitive media map for determining playback sequence for each of the plurality of playback sensitive media units.

Additionally in accordance with an embodiment of the present invention the providing the content package further includes adding a playback package map for determining playback sequence for each of the non-playback sensitive media units and for playback of the selected playback sensitive media unit.

Moreover in accordance with an embodiment of the present invention the playing back the at least one non-playback sensitive media unit and the selected playback sensitive media unit by the media playback device includes playing back the non-playback sensitive media unit entirely and without interruption, and playing back the selected playback sensitive media unit entirely and without interruption.

Further in accordance with an embodiment of the present invention the playing back the at least one non-playback sensitive media unit and the selected playback sensitive media unit by the media playback device includes at least one of interrupting playback of the non-playback sensitive media unit with playback of at least a portion of the selected playback sensitive media unit, or interrupting playback of the selected playback sensitive media unit with the playback of at least a portion of non-playback sensitive media unit.

Still further in accordance with an embodiment of the present invention the method also includes providing a rules engine, wherein the selecting at least one playback sensitive media unit is performed according to a plurality of rules and according to the at least one playback condition by the rules engine.

Additionally in accordance with an embodiment of the present invention the media playback device includes a television receiver for receiving a television signal and a display device in communication with the television receiver, wherein the playing back the at least one non-playback sensitive media unit and the selected playback sensitive media unit by the media playback device includes displaying television signals of the at least one non-playback sensitive media unit and the selected playback sensitive media unit by the display device.

Moreover in accordance with an embodiment of the present invention the television receiver receives a television signal selected from the group consisting of a broadcast television signal, a unicast signal, a multicast signal, a signal transmitted over a cellular telephone network, a signal transmitted over a computer network, a signal transmitted by satellite and a signal transmitted by a cable television network.

Further in accordance with an embodiment of the present invention the selected playback sensitive media unit includes advertising.

Still further in accordance with an embodiment of the present invention the at least one playback condition is selected from the group consisting of a temporal condition, a media playback device condition, and a compound condition including a. plurality of playback conditions.

Additionally in accordance with an embodiment of the present invention the media playback device condition includes one or more of a media playback device location condition, a media playback device viewer condition or a media playback device hardware condition.

There is also provided in accordance with another embodiment of the present invention a system for managing playback sensitive content for a media playback device, including a content package creator for packaging a content package including at least one non-playback sensitive media unit and a plurality of playback sensitive media units, a media transmission system for transmitting the content package, the media transmission system being in communication with the media playback device, a condition reader for determining at least one playback condition upon initiation of playback by the media playback device, and a selector for selecting at least one playback sensitive media unit from the plurality of playback sensitive media units according to the at least one playback condition to form a selected playback sensitive media unit.

Further in accordance with an embodiment of the present invention the media playback device further includes a media display device for displaying the at least one non-playback sensitive media unit and the selected playback sensitive media unit upon playback by the media playback device, wherein the selector combines the at least one non-playback sensitive media unit and the selected playback sensitive media unit for playback.

Still further in accordance with an embodiment of the present invention the media playback device further includes a rules engine for determining at least one playback sensitive media unit to be selected according to a plurality of rules and according to the at least one playback condition.

Additionally in accordance with an embodiment of the present invention the media playback device includes a television receiver for receiving television signals.

Moreover in accordance with an embodiment of the present invention the television receiver receives a television signal selected from the group consisting of a broadcast television signal, a unicast signal, a multicast signal, a signal transmitted over a cellular telephone network, a signal transmitted over a computer network, a signal transmitted by satellite and a signal transmitted by a cable television network.

Further in accordance with an embodiment of the present invention the selected playback sensitive media unit includes advertising.

Still further in accordance with an embodiment of the present invention the at least one playback condition is selected from the group consisting of a temporal condition, a media playback device condition, and a compound condition including a plurality of playback conditions.

Additionally in accordance with an embodiment of the present invention the media playback device condition includes one or more of a media playback device location condition, a media playback device viewer condition or a media playback device hardware condition.

Moreover in accordance with an embodiment of the present invention the condition reader is located at the media playback device.

Further in accordance with an embodiment of the present invention the condition reader is located remotely from the media playback device.

There is also provided in accordance with another embodiment of the present invention a method for managing playback sensitive content for a media playback device, including receiving, by the media playback device, a content package including at least one non-playback sensitive media unit and a plurality of playback sensitive media units, determining at least one playback condition upon initiation of playback by the media playback device, and selecting at least one playback sensitive media unit from the plurality of playback sensitive media units according to the at least one playback condition to form a selected playback sensitive media unit.

There is also provided in accordance with still another embodiment of the present invention a system for managing playback sensitive content for a media playback device, the media playback device receiving the content as packaging a content package including at least one non-playback sensitive media unit and a plurality of playback sensitive media units, the system including a condition reader for determining at least one playback condition upon initiation of playback by the media playback device, and a selector for selecting at least one playback sensitive media unit from the plurality of playback sensitive media units according to the at least one playback condition to form a selected playback sensitive media unit.

### BRIEF DESCRIPTION OF THE DRAWINGS

The present invention will be understood and appreciated more fully from the following detailed description, taken in conjunction with the drawings in which:

FIG. 1 shows a simplified block diagram illustration of a system for managing playback sensitive content, the system being constructed and operative in accordance with an exemplary embodiment of the present invention;

FIGS. 2 and 3A-3B show some non-limiting examples of playback sensitive media units combined with non-playback sensitive units in a content package;

FIG. 4 shows a flowchart of an exemplary, illustrative method for the operation of the system of FIG. 1; and

FIG. 5 shows a simplified block diagram illustration of a system for managing playback sensitive content, the system being constructed and operative in accordance with an exemplary embodiment of the present invention in which the media playback device is a television signal receiver.

### DETAILED DESCRIPTION OF SOME EMBODIMENTS

The present invention, in at least some embodiments seeks to provide a system and method for system and method for managing playback sensitive content for a media playback device.

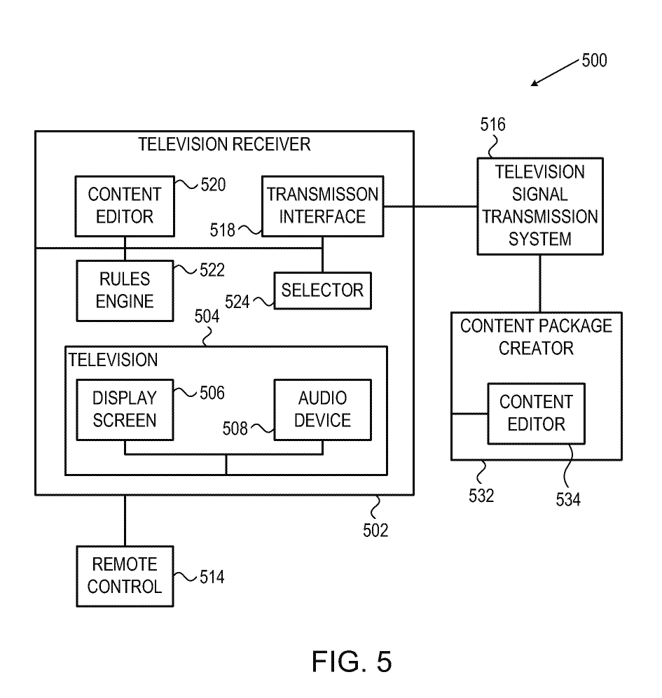

Various implementations of the device for operating the game and the single display device are encompassed different embodiments of the present invention; a non-limiting example as provided herein relates to a television signal receiver as the media playback device, although it is understood that optionally many different types of media playback devices could optionally be implemented for playing back media according to various embodiments of the present invention. Other non-limiting examples of media playback devices according to different embodiments of the present invention include any appropriate type of audio playback devices, any appropriate type of media playback devices, gaming devices, electronic devices for displaying text and so forth. Also the television signal receiver is not necessarily part of a system of the below type as described with regard to FIG. 5. The description below is intended as a non-limiting example only.

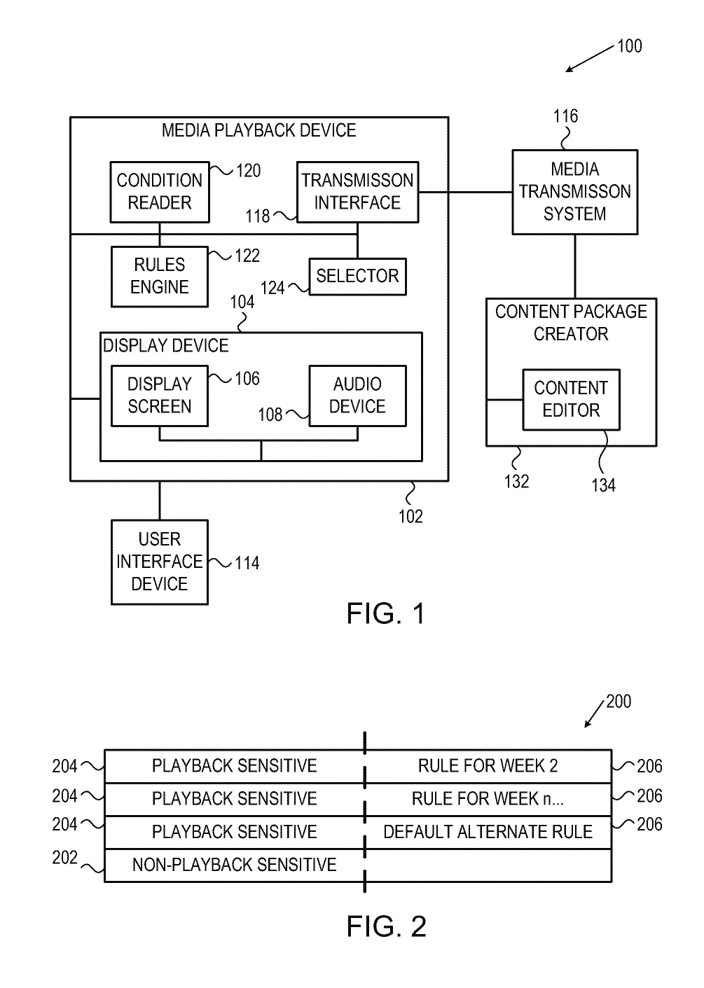

Reference is now made to FIG. 1 which is a simplified block diagram illustration of a system for managing playback sensitive content, the system being constructed and operative in accordance with an exemplary embodiment of the present invention.

As shown, a system 100 features a media playback device 102 for playing back media of any appropriate type. Media playback device 102 includes a display device 104; for this non-limiting example, display device 104 optionally features a display screen 106 and also optionally includes an audio playback device 108.

Media playback device 102 also optionally is in communication with a user interface device 114 for issuing commands to media playback device 102, which may optionally be in wired or wireless communication.

Media playback device 102 is optionally in communication with a media transmission system 116 for transmitting content. As shown, optionally media playback device 102 communicates with media transmission system 116 through a transmission interface 118. Media transmission system 116 may optionally be any appropriate type of such a network; an optional non-limiting example of the network with regard to transmission of television signals is described with regard to FIG. 5.

In system 100, media transmission system 116 may optionally transmit any appropriate type of content according to any suitable transmission protocol. However, the content is assumed to be transferred in the form of content packages, the construction of which is described in greater detail below. Briefly, each content package includes at least one non-playback sensitive media unit and a plurality of playback sensitive media units. For playback to occur, the at least one non-playback sensitive media unit is combined with at least one selected playback sensitive media unit (optionally only one playback sensitive media unit is selected; alternatively more than one is selected) according to at least one playback condition.

Upon receiving the content in the form of a content package by media playback device 102 from media transmission system 116 through transmission interface 118, a condition reader 120 within media playback device 102 determines at least one playback condition. The condition is optionally is selected from the group consisting of a temporal condition, a media playback device condition, and a compound condition comprising any appropriate plurality of playback conditions. The temporal condition for example is optionally selected from one or more of time of day, day of the week, month, specific date, season, a day or days on which a special event occurs (for example and without limitation a holiday, a day or days on which a particular sports event occurs and so forth), a particular period of time (such as a particular week or another time period) and so forth. The temporal condition may optionally also be associated with a specific user interacting with media playback device 102, for example according to the “typical” behavior of such a user in terms of requested content and so forth.

The media playback device condition optionally comprises one or more of a media playback device location condition, a media playback device viewer condition or a media playback device hardware condition. The location may optionally refer to a geographical location or to a virtual “location” on media transmission system 116, for example a network node. The media playback device viewer condition may optionally relate to a parameter that is specific to the user interacting with media playback device 102. The media playback device hardware condition may optionally relate to a limitation or capability of media playback device 102.

Condition reader 120 optionally determines the one or more media playback conditions upon initiation of playback of the content package by media playback device 102.

According to at least some embodiments, media playback device 102 optionally further comprises a rules engine 122 for determining which one or more playback sensitive media units are to be selected according to a plurality of rules and according to the at least one playback condition as determined by condition reader 120. The rules for example may optionally be adjusted according to one or more characteristics of the at least one non-playback sensitive media unit and the plurality of the playback sensitive media units and/or according to one or more characteristics of media playback device 102 and/or of the user interacting with media playback device 102. Rules engine 122 is also optionally located at media transmission system 116, for example at a server (not shown).

Media playback device 102 also optionally comprises a selector 124 for selecting at least one playback sensitive media unit from the plurality of playback sensitive media units according to at least one playback condition, and optionally also according to input from rules engine 122, to form a selected playback sensitive media unit. The selected playback sensitive media unit optionally comprises advertising, although other types of content may also optionally be provided, additionally or alternatively.

The selected playback sensitive media unit or units and the at least one non-playback sensitive media unit are then combined by selector 124. For example, according to at least some embodiments of the present invention, the units may optionally be combined so that playback of the non-playback sensitive media unit may optionally be interrupted with playback of at least a portion of the selected playback sensitive media unit, such that the latter is inserted within the former, or alternatively optionally by interrupting playback of the selected playback sensitive media unit with playback of at least a portion of the non-playback sensitive media unit.

Any suitable implementation for combining such units by selector 124 may optionally be used and could easily be selected by one of ordinary skill in the art. One non-limiting example of a selection and combination mechanism is described with regard to published PCT Application No. WO 2004/072935 to Shelton et al, in which at least one of a plurality of video frames includes a plurality of sub-pictures; one of the plurality of sub-pictures is then selected and displayed. Although the sub-pictures are described as representing alternative backgrounds for the display, in fact this method is not limited to such representation and could also optionally be implemented with regard to selector 124.

Another non-limiting example for combining such units is described with regard to published PCT Application No. WO 2005/122688 to White et al, which describes a splicing system for switching between segments of video data and which is hereby incorporated by reference only with regard to FIG. 1 and the accompanying description.

Yet another non-limiting example for combining such units is described with regard to published PCT Application No. WO 2009/133427 to Taylor et al, which describes a method for replacing portions of video data (such as replacing commercials as a non-limiting example) and which is hereby incorporated by reference only with regard to FIGS. 5-7 and the accompanying description.

According to other embodiments of the present invention, the units may optionally be combined so that the non-playback sensitive media unit is played back entirely and without interruption, and then the selected playback sensitive media unit is played back entirely and without interruption.

After being combined, the combined units are provided to display device 104 at media playback device 102, for display, as previously described.

In order to prepare the content package, optionally system 100 further comprises a content package creator 132 for packaging a content package comprising at least one non-playback sensitive media unit and a plurality of playback sensitive media units. Although content package creator 132 is shown as being separate from media transmission system 116, in fact content package creator 132 may optionally be part of media transmission system 116.

Content package creator 132 optionally combines the at least one non-playback sensitive media unit and a plurality of playback sensitive media units to form the content package. For example, optionally each such unit is prepared as a separate file and the files are then combined to form the content package. Content package creator 132 also optionally adds a label to each playback sensitive media unit, the label comprising playback data regarding at least one playback condition, such that determining at least one playback condition comprises reading playback data from the label.

Content package creator 132 may also optionally include a content editor 134 for constructing each playback sensitive media unit with at least one constant portion and at least one variable portion, wherein the at least one constant portion is shared by the plurality of playback sensitive media units. For example, content editor 134 may optionally receive at least one constant portion that forms the “core” of each playback sensitive media unit, which may optionally be placed at a suitable time location within the playback sensitive media unit. If the content of the media itself is provided in a subdivided format (for example with regard to the MPEG format, that provides video as a series of frames), optionally the constant portion may occupy a portion of one or more frames.

The constant and variable portions may optionally be constructed through the provision of a script for example, which determines which portions may optionally be combined together (for example, the constant portion may optionally be combined with any suitable variable portion, but not all variable portions may be combined together or even only one variable portion may be combined with the constant portion). The portions are optionally constructed so that they may be more easily reassembled according to the above described splicing technology.

The constant and variable portions of the playback sensitive content may optionally be determined according to various “story lines” which may for example optionally be created with regard to corresponding business rules. For example, for advertising, it is possible that the “story lines” relate to advertising goals.

Content editor 134 also optionally allows playback sensitive media units and non-playback sensitive media units to be selected and labeled as such. Furthermore, the rules may optionally be selected and applied through content editor 134, and/or may optionally be selected and applied automatically by content package creator 132.

Content package creator 132 may then optionally package a single copy of each constant portion with a plurality of variable portions to form a plurality of playback sensitive media units, in which case selector 124 selects the single copy of each constant portion and each variable portion of at least one playback sensitive media unit for playback. Content package creator 132 also optionally adds at least one playback instruction, which comprises information for playing back the variable portion. Content package creator 132 also optionally adds a label as described above.

According to at least some embodiments of the present invention, content package creator 132 may add a playback sensitive media map for determining playback sequence for each of the plurality of playback sensitive media units and/or for determining playback sequence for each of said non-playback sensitive media units and for playback of said selected playback sensitive media unit. The map for example may optionally comprise an index, listing the start and stop times for each unit, and also the name of the file (if separate files are used as described above).

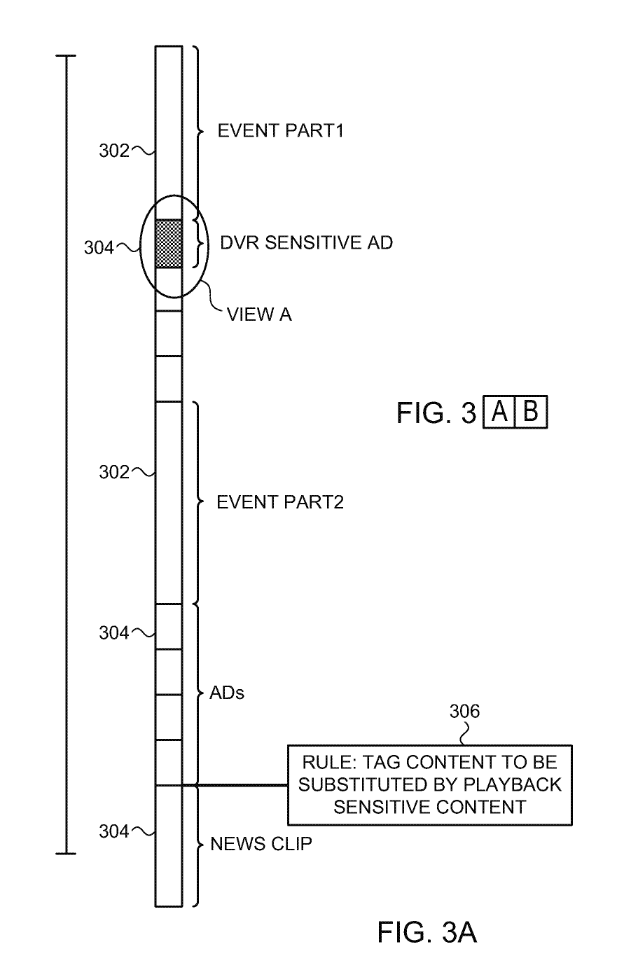

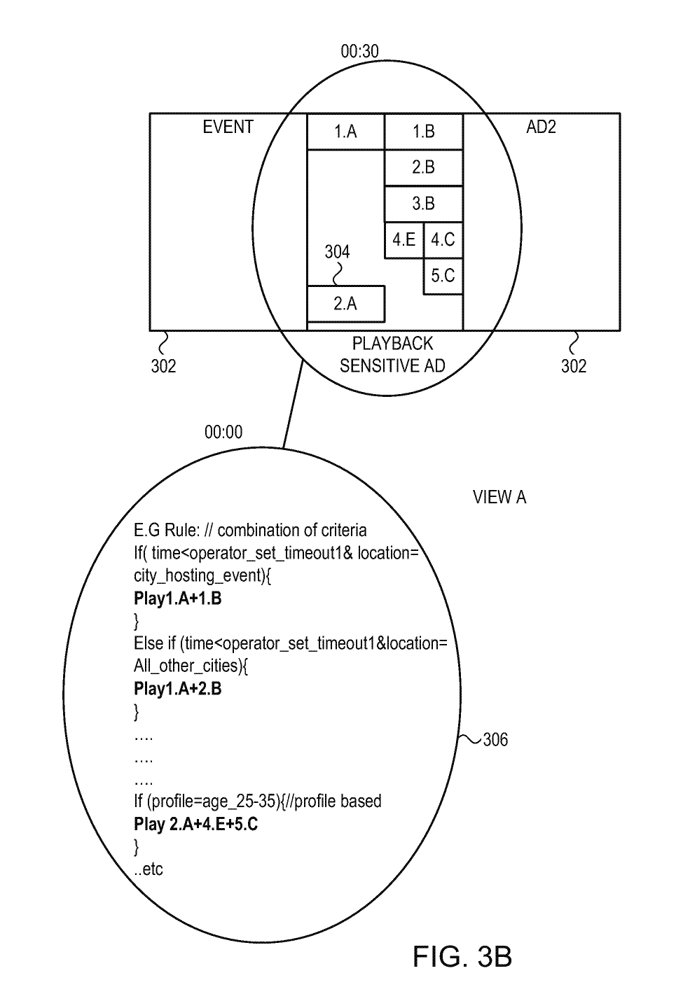

Some non-limiting examples of playback sensitive media units combined with non-playback sensitive units in a content package are shown in FIGS. 2 and 3A-3B. FIG. 2 shows a content package 200, with a non-playback sensitive unit 202 and a plurality of playback sensitive units 204, with a plurality of rules 206 which determine which playback sensitive unit 204 should be selected. Rules 206 are time based rules and as shown are for week 2, week n and an alternative default rule, in case no other rule applies. Rules 206 are optionally evaluated and applied by the rules engine described above (not shown, see FIG. 1).

FIGS. 3A-3B show a content package 300, with a plurality of non-playback sensitive units 302, optionally including non-playback sensitive advertisements as shown, and a plurality of playback sensitive units 304. One set of playback sensitive units 304 is labeled as a “DVR sensitive advertisement”, meaning that the specific playback sensitive unit 304 to be played back is optionally selected according to one or more conditions associated with recording and then playing back content package 300. As shown in the enlarged section, the specific playback sensitive unit 304 is selected according to a plurality of rules 306. It should be noted that not all advertisements are necessarily playback sensitive; in the enlarged section, at least one advertisement is shown as being a non-playback sensitive unit 302. Furthermore, at least one playback sensitive unit 304 is shown (to the right of content package 300) as being a “news clip”, which is optionally played back or not played back according to at least one rule 306.

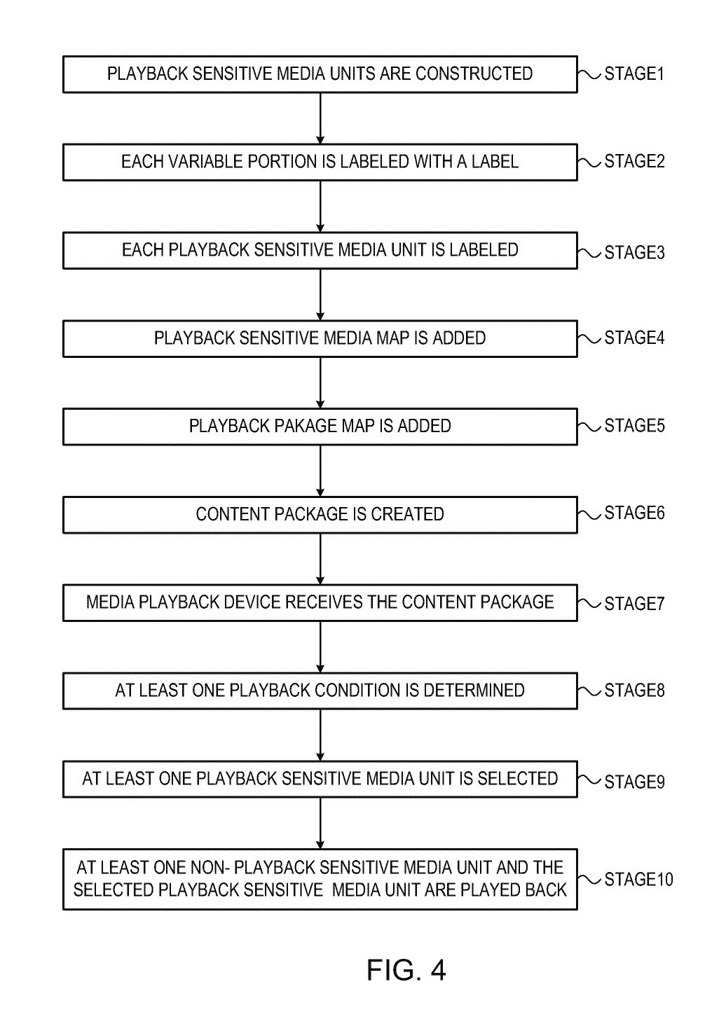

FIG. 4 shows a flowchart of art exemplary, illustrative method that may optionally be implemented with the system of FIG. 1. As shown, in stage 1 a plurality of playback sensitive media units is constructed; optionally, each playback sensitive media unit is constructed with at least one constant portion and at least one variable portion, such that at least one constant portion is shared by a plurality of playback sensitive media units, for example with the content editor as described above. Optionally, a single copy of each constant portion is combined with a plurality of variable portions to form a plurality of playback sensitive media units. The playback sensitive media unit may optionally comprise advertising.

In stage 2, each variable portion may be labeled with a label comprising playback data regarding at least one playback condition and at least one playback instruction, such that the at least one playback instruction comprises information for playing back the variable portion.

In stage 3, a label is optionally added to each playback sensitive media unit, the label comprising playback data regarding at least one playback condition.

Optionally, stages 1-3 are performed in a different order.

In stage 4, a playback sensitive media map for determining the playback sequence for each of the plurality of playback sensitive media units is optionally added to the plurality of playback sensitive media units.

In stage 5, a playback package map may be added for determining playback sequence for each of the non-playback sensitive media units and for playback of each playback sensitive media unit.

In stage 6, a content package may be created from the plurality of playback sensitive media units and at least one non-playback sensitive media unit, for example by the above described content package creator, comprising at least one non-playback sensitive media unit and a plurality of playback sensitive media units.

In stage 7, a media playback device receives the content package.

In stage 8, at least one playback condition is determined upon initiation of playback by the media playback device. Optionally, the at least one playback condition is determined by reading the playback data from the label. Additionally or alternatively, one or more rules are applied to determine which playback sensitive media unit is to be selected.

In stage 9, at least one playback sensitive media unit is selected from the plurality of playback sensitive media units according to the at least one playback condition to form a selected playback sensitive media unit. Optionally, selecting the at least one playback sensitive media unit for playback comprises selecting a single copy of each constant portion and each variable portion of the at least one playback sensitive media unit for playback.

In stage 10, at least one non-playback sensitive media unit and the selected playback sensitive media unit may be played back by the media playback device, either separately and without interruption, or alternatively by periodically interrupting each such unit to play a portion (or the entirety) of another such unit.

FIG. 5 shows a simplified block diagram illustration of a system 500 for managing playback sensitive content, the system being constructed and operative in accordance with an exemplary embodiment of the present invention in which the media playback device is a television signal receiver. As noted previously, the present invention is not limited to such an implementation with a television signal receiver or indeed with television signals or even video as the media type; such an implementation is a non-limiting example only. The components of system 500 which have the same or similar function as components in FIG. 1 have the same reference numbers plus 400.

Optionally, the system 500 includes a television signal receiver 502 for receiving television signals from a television signal transmission system 516, which may optionally include a satellite, broadcasting, a cable network, through any appropriate type of unicast or multicast technology, over a computer network or from a cellular telephone network (not shown). The term “broadcaster” optionally refers to any appropriate entity transmitting content over the transmission network, or the transmission network itself or a part thereof. By “television signal” it is meant various types of transmitted material, such as television programs, commercials, video clips, program guides and electronic program guides (EPGs), data, multimedia information, hypermedia links, computer programs, computer data and applications which may be downloaded, program applets and teletex.

Television signal receiver 502 may be in communication, which may optionally be wired or wireless communication, with a remote control 514. Television signal receiver 502 also includes a television 504 as shown.

The operation of system 500 is highly similar to that of system 100 of FIG. 1; however for system 500, the content is typically provided as video data and the viewer experiences the combined, spliced video data as a seamless “story”, such that the content is also optionally adjusted so that video data forms such a “story”, regardless of which playback sensitive media unit(s) are selected.

It is appreciated that components of the present invention described herein as being implemented in software may, if desired, be implemented in ROM (read only memory) form. The components described herein as being implemented in software may, generally, be implemented in hardware, if desired, using conventional techniques.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1. A method for managing playback sensitive content for a media playback device, comprising:
providing a content package comprising at least one non-playback sensitive media unit and a plurality of playback sensitive media units, said providing comprising adding a label to each playback sensitive media unit, said label comprising playback data regarding at least one playback condition, said providing also comprising packaging a single copy of each constant portion with a plurality of variable portions to form said plurality of playback sensitive media units, said packaging each playback sensitive media unit further comprising labeling each variable portion with said label comprising playback data regarding at least one playback condition and at least one playback instruction, said at least one playback instruction comprising information for playing back said variable portion;
receiving said content package by the media playback device;
determining at least one playback condition upon initiation of playback by the media playback device, said determining said at least one playback condition comprises reading said playback data from said label;
selecting at least one playback sensitive media unit from said plurality of playback sensitive media units according to said at least one playback condition to form a selected playback sensitive media unit, said selecting said at least one playback sensitive media unit for playback comprising selecting said single copy of each constant portion and each variable portion of said at least one playback sensitive media unit for playback; and
playing back said at least one non-playback sensitive media unit and said selected playback sensitive media unit by the media playback device,
wherein said packaging said single copy of each constant portion with said plurality of variable portions to form said plurality of playback sensitive media units further comprises adding a playback sensitive media map for determining playback sequence for each of said plurality of playback sensitive media units, said playback sensitive media map comprising an index comprising at least start and stop times for each said playback sensitive media unit.

2-7. (canceled)

8. The method according to claim 1, wherein said providing said content package further comprises adding a playback package map for determining playback sequence for each of said non-playback sensitive media units and for playback of said selected playback sensitive media unit.

9. The method according to claim 8, wherein said playing back said at least one non-playback sensitive media unit and said selected playback sensitive media unit by the media playback device comprises playing back said non-playback sensitive media unit entirely and without interruption, and playing back said selected playback sensitive media unit entirely and without interruption.

10. The method according to claim 8, wherein said playing back said at least one non-playback sensitive media unit and said selected playback sensitive media unit by the media playback device comprises at least one of interrupting playback of said non-playback sensitive media unit with playback of at least a portion of said selected playback sensitive media unit, or interrupting playback of said selected playback sensitive media unit with said playback of at least a portion of non-playback sensitive media unit.

11. The method according to claim 1, further comprising providing a rules engine, wherein said selecting at least one playback sensitive media unit is performed according to a plurality of rules and according to said at least one playback condition by said rules engine.

12. The method according to claim 1, wherein the media playback device comprises a television receiver for receiving a television signal and a display device in communication with said television receiver, wherein said playing back said at least one non-playback sensitive media unit and said selected playback sensitive media unit by the media playback device comprises displaying television signals of said at least one non-playback sensitive media unit and said selected playback sensitive media unit by said display device.

13. The method according to claim 12, wherein said television receiver receives a television signal selected from the group consisting of a broadcast television signal, a unicast signal, a multicast signal, a signal transmitted over a cellular telephone network, a signal transmitted over a computer network, a signal transmitted by satellite and a signal transmitted by a cable television network.

14. The method according to claim 12, wherein said selected playback sensitive media unit comprises advertising.

15. The method according to claim 1, wherein said at least one playback condition is selected from the group consisting of a temporal condition, a media playback device condition, and a compound condition comprising a plurality of playback conditions.

16. The method according to claim 15, wherein said media playback device condition comprises one or more of a media playback device location condition, a media playback device viewer condition or a media playback device hardware condition.

17. A system for managing playback sensitive content for a media playback device, comprising:
a content package creator for packaging a content package comprising at least one non-playback sensitive media unit and a plurality of playback sensitive media units, said content package creator adding a label to each playback sensitive media unit, said label comprising playback data regarding at least one playback condition, said content package creator also packaging a single copy of each constant portion with a plurality of variable portions to form said plurality of playback sensitive media units, said content package creator also labeling each variable portion with said label comprising playback data regarding at least one playback condition and at least one playback instruction, said at least one playback instruction comprising information for playing back said variable portion;
a media transmission system for transmitting said content package, said media transmission system being in communication with the media playback device;
a condition reader for determining at least one playback condition upon initiation of playback by the media playback device by reading said playback data from said label;
a selector for selecting at least one playback sensitive media unit from said plurality of playback sensitive media units according to said at least one playback condition to form a selected playback sensitive media unit, said selector selecting said a copy of each constant portion and each variable portion of said at least one playback sensitive media unit for playback; and
a media display device for displaying said at least one non-playback sensitive media unit and said selected playback sensitive media unit upon playback by the media playback device, wherein said selector combines said at least one non-playback sensitive media unit and said selected playback sensitive media unit for playback,
wherein said packaging said single copy of each constant portion with said plurality of variable portions to form said plurality of playback sensitive media units further comprises adding a playback sensitive media map for determining playback sequence for each of said plurality of playback sensitive media units, said playback sensitive media map comprising an index comprising at least start and stop times for each said playback sensitive media unit.

18. (canceled)

19. The system according to claim 17, wherein the media playback device further comprises a rules engine for determining at least one playback sensitive media unit to be selected according to a plurality of rules and according to said at least one playback condition.

20. The system according to claim 17, wherein the media playback device comprises a television receiver for receiving television signals.

21. The system according to claim 20, wherein said television receiver receives a television signal selected from the group consisting of a broadcast television signal, a unicast signal, a multicast signal, a signal transmitted over a cellular telephone network, a signal transmitted over a computer network, a signal transmitted by satellite and a signal transmitted by a cable television network.

22. The system according to claim 20, wherein said selected playback sensitive media unit comprises advertising.

23. The system according to claim 17, wherein said at least one playback condition is selected from the group consisting of a temporal condition, a media playback device condition, and a compound condition comprising a plurality of playback conditions.

24. The system according to claim 23, wherein said media playback device condition comprises one or more of a media playback device location condition, a media playback device viewer condition or a media playback device hardware condition.

25. The system according to claim 17, wherein said condition reader is located at the media playback device.

26. The system according to claim 17, wherein said condition reader is located remotely from the media playback device.

27 and 28: (canceled)
